(19) United States
(12) Patent Application Publication
(10) Pub. No.: US 2018/0268583 A1
(43) Pub. Date: Sep. 20, 2018

(54) METHOD FOR GENERATING A SINGLE REPRESENTATIVE IMAGE FROM MULTI-VIEW IMAGES

(71) Applicant: KOREA ADVANCED INSTITUTE OF SCIENCE AND TECHNOLOGY, Daejeon (KR)

(72) Inventors: Jun Yong Noh, Daejeon (KR); Young Hui Kim, Daejeon (KR); Kye Hyun Kim, Daejeon (KR)

(21) Appl. No.: 15/460,461

(22) Filed: Mar. 16, 2017

(51) Int. Cl. G06T 11/60; H04N 19/426; H04N 19/136; H04N 19/182; H04N 19/93

(52) U.S. Cl. CPC G06T 11/60; H04N 19/426; H04N 19/93; H04N 19/182; H04N 19/136

(57) ABSTRACT

Provided is a method for generating a single representative image from multi-view images, in which multi-view images captured from two or more viewpoints are combined into a single image using depth information, including identifying visible information from different viewpoints for pixels in each view image using depth information, identifying context of the pixels in all viewpoints using the acquired visible information and the depth information, and combining into a single image, compressing the combined image based on color information, and compressing viewpoint information of pixels in the compressed image.

### BACKGROUND OF THE INVENTION

### Field of the Invention

The present disclosure relates to combining multi-view images captured from two or more viewpoints into a single image using depth information.

### Description of the Related Art

As conventional technique to combine multi-view images captured from two or more viewpoints into a single image using depth information, Korea Patent No. 10-0989435 discloses a method for processing a multi-view image including enabling the three-dimensional (3D) warping on a depth map obtained by a depth camera to a multi-view camera's viewpoint to obtain a multi-view depth map, generating a multi-view tri-map corresponding to the multi-view image obtained by the multi-view camera using the multi-view depth map, generating a multi-view alpha matte corresponding to the multi-view image using the multi-view tri-map, and applying the multi-view alpha matte to the multi-view image to extract a multi-view foreground, wherein generating each tri-map that constitutes the multi-view tri-map at the step of generating the multi-view tri-map includes determining a foreground region in the 3D warped depth map using each image that constitutes the multi-view image and each 3D warped depth map that constitutes the multi-view depth map, and filling holes created by the 3D warping in the foreground region; and generating the tri-map from the hole-filled depth map.

### SUMMARY OF THE INVENTION

The present disclosure is directed to providing a method for generating a single representative image from multi-view images, in which when multi-view images captured from two or more viewpoints and their corresponding depth information are present, the multi-view images are combined into a single representative image for easy image editing and to increase the compression efficiency.

To achieve the objective of the present disclosure, according to an aspect of the present disclosure, there is provided a method for generating a single representative image from multi-view images, in which multi-view images captured from two or more viewpoints are combined into a single image using depth information, including identifying visible information from different viewpoints for pixels in each view image using depth information, identifying context of the pixels in all viewpoints using the acquired visible information and the depth information and combining into a single image, compressing the combined image based on color information, and compressing viewpoint information of pixels in the compressed image.

According to the present disclosure, all the objectives of the present disclosure described previously can be achieved. Specifically, in technical aspects, compression efficiency of multi-view images increases, and synthesis and editing efficiency of multi-view contents is enhanced.

In the content industry, moreover, it is expected to promote development of glasses-free multi-view stereoscopic imaging industry and improve the efficiency in creating multi-view three-dimensional stereoscopic images.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 is a flowchart showing the operation of a method for generating a single representative image from multi-view images according to an embodiment of the present disclosure.

FIG. 2 shows an example of inputted multi-view image and its corresponding depth information.

FIG. 3 shows an example of compressed single representative color information (color domain change, a black region indicates that stored information is absent).

FIG. 4 shows an example of viewpoint information additionally compressed by run length encoding (a region in which information is present is indicated in white).

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “module”, a “block” or like, when used in the specification, represents a unit that processes at least one function or operation, and the unit or the like may be implemented by hardware or software or a combination of hardware and software.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the disclosure to those skilled in the art.

A method for generating a single representative image from multi-view images according to the present disclosure combines multi-view images captured from two or more viewpoints into a single image using depth information, and includes identifying visible information from different views for pixels in each view image using depth information, identifying the context of the pixels in all viewpoints using the acquired visible information and the depth information and combining into a single image, compressing the combined image based on color information to be suited for a purpose, and additionally compressing viewpoint information of pixels in the compressed image.

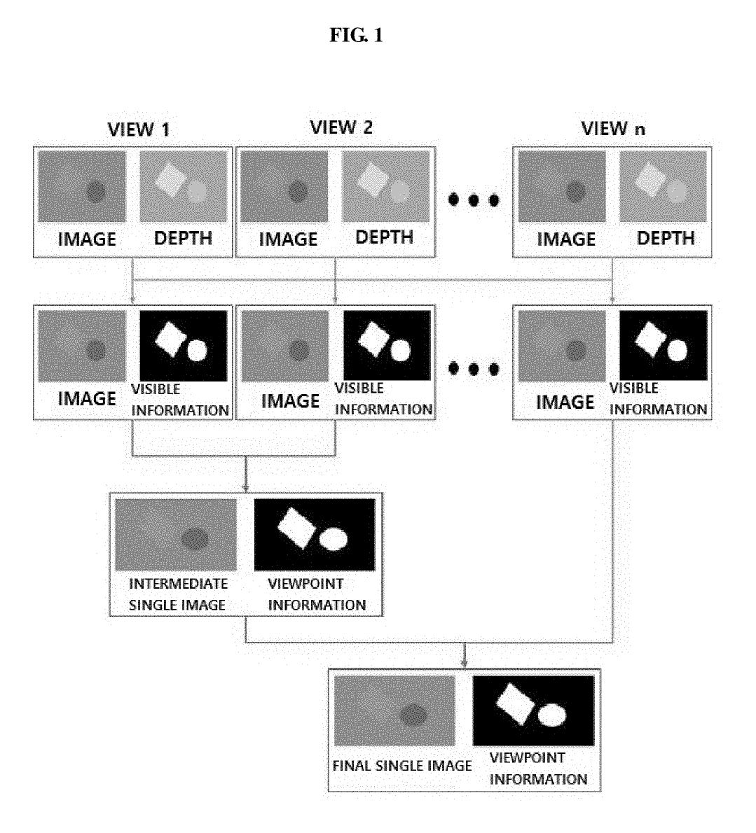

FIG. 1 is a flowchart showing the operation of a method for generating a single representative image from multi-view images according to an embodiment of the present disclosure. The following is a description of the method for generating a single representative image from multi-view images according to an embodiment of the present disclosure by referring to FIG. 1.

1. Input Step

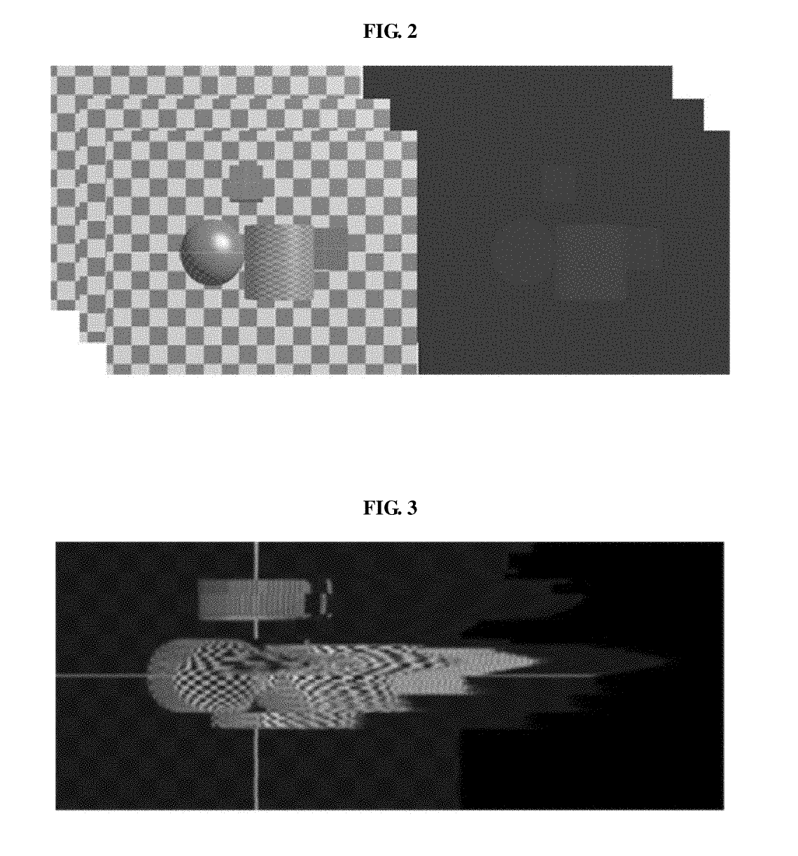

Inputs of images captured from n viewpoints and depth information corresponding to each image, and intrinsic and extrinsic parameters of cameras that captured each image are received as initial input. In this instance, the inputted information should be depth information having the same resolution as the image without error by denoising and upsampling of information acquired by a general depth information acquisition device. FIG. 2 shows an example of inputted multi-view image and its corresponding depth information.

2. Visible Information Extraction Step

For pixels of each inputted image, visible information from another viewpoint is acquired using depth information from a corresponding viewpoint. First, all the pixels are re-projected to all other viewpoints using camera parameters and depth information. Furthermore, after comparing depth information at the projected position in each viewpoint, when a depth value in an original viewpoint is larger than or equal to a depth value in a projected viewpoint, it is determined to be visible from the corresponding viewpoint. In this instance, in order to compensate with noise, the depth values are compared with some threshold, and along with this, color information is compared, helping visibility determination. After this process is performed, visible information for identifying if a pixel is visible from another viewpoint is acquired for each pixel of all images. This information is stored in bits for each pixel, and for example, if a pixel of view 2 in multi-view images from 8 viewpoints is visible from views 1-3 and is not visible from views 4-8, visible information of the corresponding pixel is 11100000.

3. Single Image Generation Step

Single image generation is performed on each row. First, leftmost pixels of each image are compared, and a pixel determined to be further left is placed at the left side of an intermediate single image. In this instance, with pixel placement, viewpoint information for recording a viewpoint of the corresponding pixel is recorded together. Subsequently, an unpositioned pixel and a pixel next to the positioned pixel are compared by the same method and positioned in the intermediate single image. This process continues until all the pixels are positioned. In this instance, determination of a further left pixel is performed as below.

In case that both two pixels being compared are visible from both sides:

When one pixel is re-projected to a viewpoint of the other pixel, a further left pixel is selected.

In case that only one of two pixels being compared is visible from both sides:

When a pixel that is visible from both sides is re-projected to a viewpoint of a pixel that is only visible from one side, a further left pixel is selected.

In case that both two pixels being compared are invisible from other view:

After re-projecting two pixels to different views, a further left pixel is selected through comparison of average values of the x coordinate in two views of each pixel.

Initially, an intermediate single image is generated from view 1 image and view 2 image using a corresponding method, and subsequently, this process is applied to the generated intermediate single image and a next view image to generate a new intermediate single image. As this process continues, a final single representative image and viewpoint information is generated.

4. Image Compression Step

The size of the single representative image having undergone the single image generation step is the size of (the size of each view image x the number of viewpoints). For this reason, the size of the image is reduced through an additional compression step. Of course, the size of the single image is large, but according to the properties of the multi-view images, most of pixels are pixels that are visible from all viewpoints, and the pixels are actually positioned adjacent to each other in the single representative image. Thus, the pixels positioned in each order have similar color. A compression process using this feature is as follows.

First, two pixels are compared, and when color is identical or similar and visible information values are the same, the pixels are combined into one. In this instance, viewpoint information of the combined pixel is stored in the same manner as the visible information value described at the visible information extraction step. For example, when pixels of view 1 and view 2 in 8 view images are combined, viewpoint information is 11000000. Subsequently, the combined pixel and a next pixel are combined when it is possible to combine the pixels through comparison of color and visible information values. This process continues, and when confronted with a pixel of the already combined viewpoint, a newly re-combined pixel is generated. When the image is compressed in this manner, a considerate amount of data can be compressed.

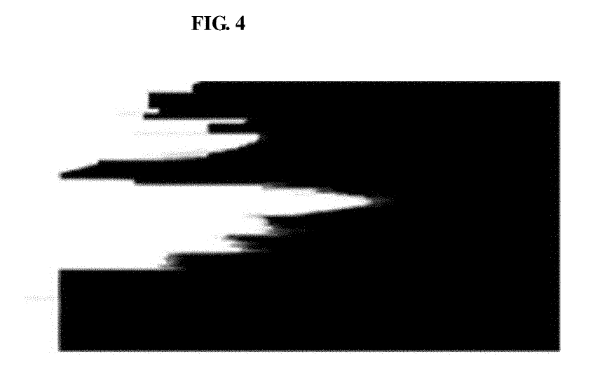

FIG. 3 shows an example of compressed single representative color information (color domain change, a black region indicates that stored information is absent).

5. Viewpoint Information Compression Step

Viewpoint information uses the properties of the multi-view images described at the image compression step. According to the properties, after the image compression step is performed, mostly viewpoint information has successive runs of the same value. Because it is easy to compress by a Run Length Encoding (RLE) algorithm, compression is performed using this one more time. FIG. 4 shows an example of viewpoint information additionally compressed by RLE (a region in which information is present is indicated in white).

6. View Image Recovery Step

To recover the image, the viewpoint information compressed at the viewpoint information compression step is recovered first. Subsequently, pixels whose viewpoint information has a value of a viewpoint to recover are sequentially selected and positioned, starting from the left pixel, so that the image from a desired viewpoint is recovered.

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims.

The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A method for generating a single representative image from multi-view images, in which multi-view images captured from two or more viewpoints are combined into a single image using depth information, the method comprising:
identifying visible information from different viewpoints for pixels in each view image using depth information;
identifying context of the pixels in all viewpoints using the acquired visible information and the depth information, and combining into a single image;
compressing the combined image based on color information; and
compressing viewpoint information of pixels in the compressed image.

2. The method of claim 1, wherein the viewpoint information of pixels are compressed by a Run Length Encoding (RLE) algorithm.

3. The method of claim 1 further comprising recovering the viewpoint information compressed at the viewpoint information compression step.

4. The method of claim 3, wherein the viewpoint information of pixels are compressed by a Run Length Encoding (RLE) algorithm.
